(19) United States
(12) Patent Application Publication
(10) Pub. No.: US 2012/0105797 A1
(43) Pub. Date: May 3, 2012

(54) EYEGLASSES WITH GOLF BALL MARKER

(76) Inventor: Gladys J. Howard, Minot, ME (US)

(21) Appl. No.: 12/915,264

(22) Filed: Oct. 29, 2010

(51) Int. Cl. G02C 11/00

(52) U.S. Cl. 351/158

(57) ABSTRACT

A pair of eyeglasses includes a magnet that creates a magnetic field capable of holding a golf ball marker. In one embodiment, the eyeglasses include a magnet mounted to one of the temple pieces such that the golf ball marker can be detachably held to the temple piece by the magnetic force of the magnet.

### BACKGROUND OF THE INVENTION

This invention relates generally to eyeglasses (also sometimes referred to as glasses or spectacles) and more particularly to eyeglasses adapted to support a golf ball marker for use by a golfer.

Golf is a game that is normally played in groups, typically groups of two, three or four players together. Because this leads to the players landing their ball on the green while playing a hole together, the use of golf ball markers for marking the location of one's ball on the green while the other golfers are putting is frequently required. In other words, a player replaces his or her golf ball with a marker in order to avoid having the ball struck by another player's ball while the other player is putting. The player is then able to replace the golf ball to the proper location on the green when it is his or her turn to putt.

Carrying a golf ball marker during a round of golf has been a longstanding problem. Perhaps the most common approach is to carry the golf ball marker in one's pocket; indeed, many golfers simply use a coin as a marker. However, it can be very difficult to dig the marker out of one's pocket, particularly when wearing a golf glove. While many alternatives to carrying the golf ball marker in the pocket have been proposed, there is still a need for a golf ball marker that is held in a convenient and readily accessible location.

### SUMMARY OF THE INVENTION

The present invention provides a pair of eyeglasses having a magnet creating a magnetic field capable of holding a golf ball marker. In one embodiment, the eyeglasses include a magnet mounted to one of the temple pieces such that the golf ball marker can be detachably held to the temple piece by the magnetic force of the magnet.

### DESCRIPTION OF THE DRAWINGS

FIG. 1 is a perspective view of a pair of eyeglasses adapted to support a golf ball maker.

FIG. 2 is an exploded view of the eyeglasses of FIG. 1.

FIG. 3 is a cross-sectional view of one embodiment of the eyeglasses of FIG. 1.

FIG. 4 is a cross-sectional view of another embodiment of the eyeglasses of FIG. 1.

FIG. 5 is a cross-sectional view of yet another embodiment of the eyeglasses of FIG. 1.

FIG. 6 is a side view of alternative embodiment of the eyeglasses of FIG. 1.

FIG. 7 is a side view of another alternative embodiment of the eyeglasses of FIG. 1.

### DETAILED DESCRIPTION OF THE INVENTION

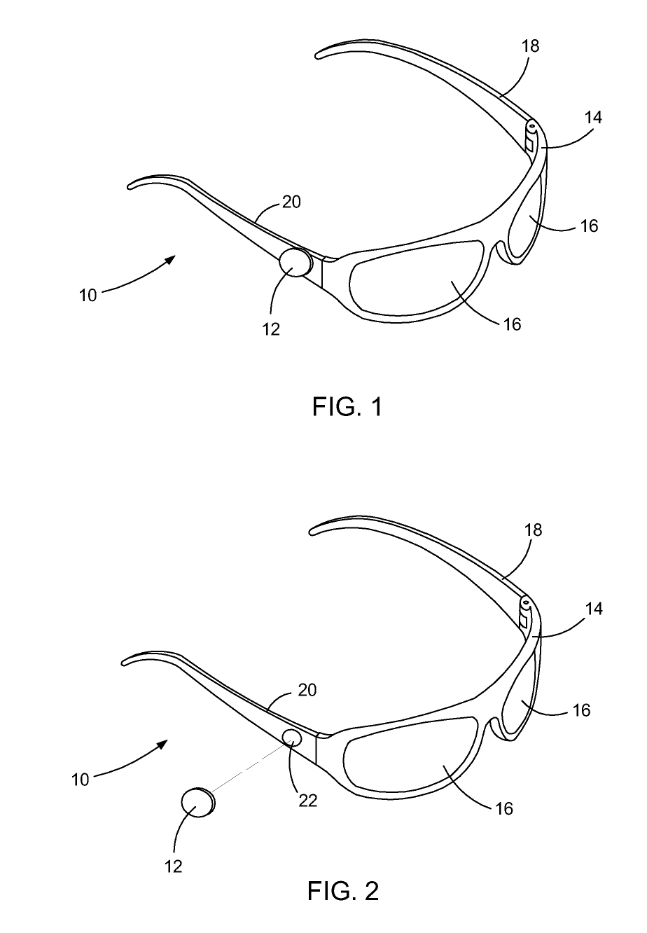

Referring to the drawings wherein identical reference numerals denote the same elements throughout the various views, FIGS. 1 and 2 show a pair of eyeglasses 10 adapted to support at least one golf ball marker 12. The eyeglasses 10 can be any type of eyeglasses, including sunglasses, prescription glasses, safety glasses or the like. In the illustrated embodiment, the eyeglasses 10 comprise a frame 14 that retains lenses 16. The eyeglasses 10 further comprise first and second temple pieces or bows 18 and 20 attached to the left and right sides, respectively, of the frame 14. The temple pieces 18 and 20 extend rearward from the frame 14 for placement over the ears of the person wearing the eyeglasses 10. In the illustrated embodiment, the temple pieces 18 and 20 are hinged to the frame 14 so as to be able to pivot with respect to the frame 14.

The eyeglasses 10 include a magnet 22 mounted to one of the temple pieces 20 for detachably holding the ball marker 12 on the temple piece 20 by magnetic force. The magnet 22 is shown in the drawings as being mounted to the right temple piece 20 for purposes of illustration only. It should be understood that the magnet 22 can be attached to either one of the two temple pieces. As a possible alternative, both of the temple pieces 18 and 20 could have a magnet mounted thereto to provide means for detachably holding two golf ball markers.

The magnet 22 creates a magnetic field that is capable of holding the golf ball marker 12. That is, the magnetic field produced by the magnet 22 is strong enough to hold the golf ball marker 12 firmly in place against the temple piece 20 such that the golf ball marker 12 will not fall off or be dislodged as the result of jostling or head movement by the person wearing the eyeglasses 10. On the other hand, the magnetic field produced by the magnet 22 is not so strong as to prevent the golf ball marker 12 from being purposely removed by hand. The golf ball marker 12 can thus be retained in a readily accessible location when not in use, but when needed, the golf ball marker 12 can be detached from the eyeglasses 10 by pulling on it to overcome the magnetic force of the magnet 22.

The golf ball marker 12 is made, at least in part, from a magnetic material (i.e., any material that is attracted to a magnetic field such as iron, cobalt and nickel). In the illustrated embodiment, the golf ball marker 12 is disc-shaped, but the golf ball marker 12 can have nearly any shape. The golf ball marker 12 typically has a diameter or cross dimension that is close to the width of the temple piece 20, as depicted in FIGS. 1 and 2, although the golf ball marker 12 can be larger or smaller than the temple piece 20 as well.

The magnet 22 is preferably a permanent magnet so as to produce a persistent magnetic field. As such the magnet 22 can be made of a magnetized ferromagnetic material, such as iron. The magnet could alternatively be made from a piece of non-magnetic material, such as an elastomer, that is embedded with magnetized particles.

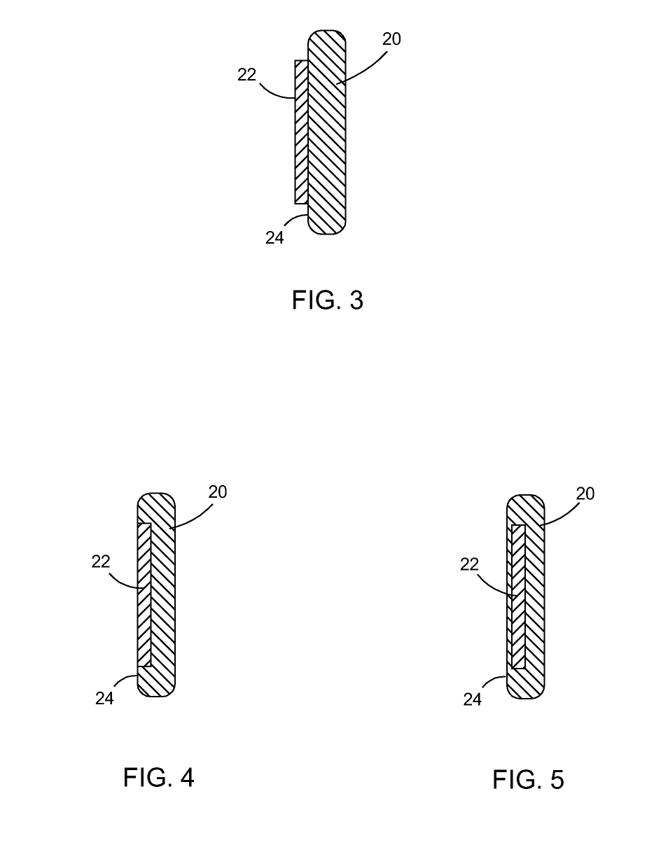

As shown in FIG. 3, which is a cross-sectional view through the temple piece 20 and the magnet 22, the magnet 22 can be mounted to the temple piece 20 by attaching the magnet 22 to the exterior surface 24 of the temple piece 20 with an adhesive or any other suitable fastening means. Alternatively, the magnet 22 can be embedded in the temple piece 20. For example, the magnet 22 can be partially embedded in the temple piece 20 having an outer surface flush with the exterior surface 24 of the temple piece 20, as shown in FIG. 4, or the magnet 22 can be fully embedded in the temple piece 20, as shown in FIG. 5. As another possible alternative, the temple piece 20 could be made of a magnetized material such that the temple piece 20 itself produces the magnetic field for detachably holding the golf ball marker 12 and thus functions as the magnet.

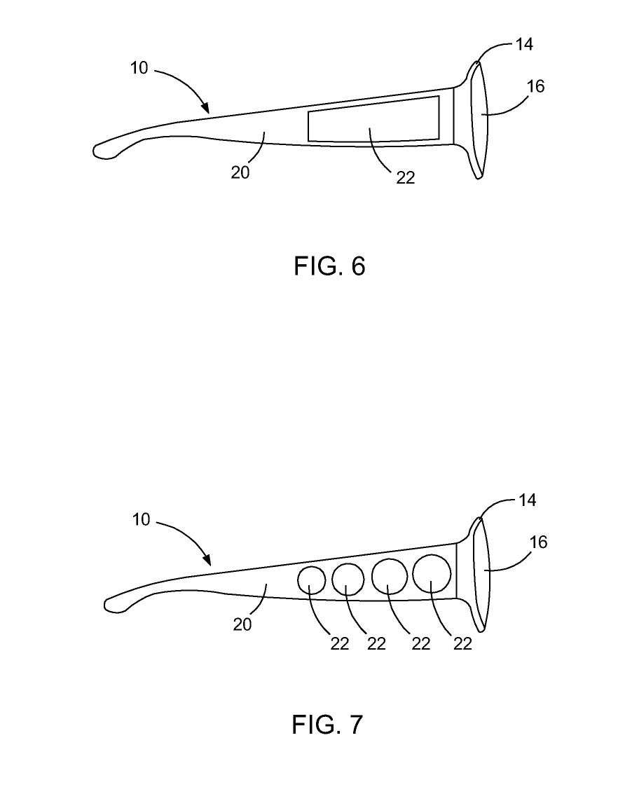

While shown in FIG. 2 as a circular disc, the magnet 22 can have any suitable shape including oval and rectangular. The magnet 22 alternatively can be similar in shape to the portion of the temple piece 20 to which it is mounted, as shown in FIG. 6. In addition, the eyeglasses 10 could have a plurality of magnets 22 disposed along the length of the temple piece 20, such as is shown in FIG. 7.

While specific embodiments of the present invention have been described, it should be noted that various modifications thereto can be made without departing from the spirit and scope of the invention as defined in the appended claims.

What is claimed is:

1. A pair of eyeglasses comprising:
a frame;
at least one temple piece attached to said frame; and
a magnet creating a magnetic field capable of holding a golf ball marker.

2. The eyeglasses of claim 1 wherein said magnet is mounted to said temple piece.

3. The eyeglasses of claim 2 wherein said magnet is attached to said temple piece.

4. The eyeglasses of claim 2 wherein said magnet is partially embedded in said temple piece.

5. The eyeglasses of claim 2 wherein said magnet is fully embedded in said temple piece.

6. The eyeglasses of claim 1 wherein said temple piece is magnetized so as to function as said magnet.

7. The eyeglasses of claim 1 wherein said magnet is a permanent magnetic.

8. A pair of eyeglasses for use by a golfer comprising:
a frame;
first and second temple pieces attached to said frame;
a magnet mounted to said first temple piece; and
a golf ball marker detachably held to said first temple piece by magnetic force from said magnet.

9. The eyeglasses of claim 8 wherein said magnet is attached to said first temple piece.

10. The eyeglasses of claim 8 wherein said magnet is partially embedded in said first temple piece.

11. The eyeglasses of claim 8 wherein said magnet is fully embedded in said first temple piece.

12. The eyeglasses of claim 8 wherein said magnet is a permanent magnetic.

13. The eyeglasses of claim 8 wherein said magnet comprises a non-magnetic material embedded with magnetized particles.

14. The eyeglasses of claim 8 wherein said magnet is similar in shape to the portion of said first temple piece to which it is mounted.

15. The eyeglasses of claim 8 further comprising a plurality of magnets disposed along said first temple piece.
